(19) United States
(12) Patent Application Publication
(10) Pub. No.: US 2011/0130871 A1
(43) Pub. Date: Jun. 2, 2011

(54) VEGETABLE TOWER

(75) Inventor: PEI-CHIEH LIN, TAICHUNG CITY (TW)

(73) Assignee: UNIVERSAL CARBON CONTROL TECHNOLOGY CO., LTD., Taichung City (TW)

(21) Appl. No.: 12/704,542

(22) Filed: Feb. 12, 2010

Related U.S. Application Data
(60) Provisional application No. 61/264,845, filed on Nov. 30, 2009.

(51) Int. Cl. G06F 7/00; A01G 9/02

(52) U.S. Cl. 700/219; 47/83; 47/79

(57) ABSTRACT

The present invention discloses a vegetable tower, which comprises a main body. A main spiral slide guide is disposed inside the main body and vegetable growing bins can be hung on the main spiral slide guide via a plurality of chains and then slipped downstream along the main spiral slide guide by means of gravity. The vegetable growing bins further comprises several supply tubes and supply inlets. A main control module is built inside the main body, and it can automatically ascend and descend inside the main body to perform identifying, feeding, catching images and measuring functionalities. The main control module can feed the vegetable growing bins with water, fertilizer, CO₂. The central management module and the main control module are integrated to be an automatic planting-care system to make the growths of the vegetables under well control.

### BACKGROUND OF THE INVENTION

1. Field of the Invention

The present invention relates to a vegetable planting system; in particular, it relates to a vegetable tower with an automatic planting-care system and centralized retrieval mechanism which can lift upward/downward of vegetable growing bins.

2. Description of Related Art

Green living with no pollution is always an ultimate goal nowadays. Due to the environmental consciousness rises, more and more power-saving and carbon-reducing productions created, such as hybrid cars, solar cells and LEDs. Nevertheless, only the carbon elements produced by human being, but not the carbon elements existed already, are reduced via these power-saving productions.

On the other hand, people all had suffered various contaminations of food that cause damage to our health; with this concern, many organic vegetables and foods are provided to provide customers with choices to substitute the ordinary one. Even though the organic vegetables and foods are really good for our health, they are expensive and difficult to be obtained due to traffic issue.

### SUMMARY OF THE INVENTION

Regarding to the aforementioned conventional drawbacks, the objective of the present invention is to provide a vegetable tower with an automatic planting-care system so at to control the growths and quality of the vegetables, and provide the functions of carbon-reducing and power-saving at the same time.

According to the objective of the present invention, a vegetable tower is herein provided, which comprises a main body with a polygonal or cylinder outside shape to reduce the resistance from the wind that hits the flat surface of the main body. A main spiral slide guide is disposed inside the main body and different kinds of vegetable growing bins can be hung on the main spiral slide guide via a plurality of chains and then slipped downstream along the main spiral slide guide. The vegetable tower further comprises a central elevator (part of the centralized retrieval system), located inside the main body, the central elevator enables a maintainer to ascend and descend for trouble shooting or hanging different kinds of vegetable growing bins thereupon. The present invention further comprises a temperature control system to keep the inner temperature of the main body stable.

Since the internal environment of vegetable tower operates under a positive atmospheric pressure than external; when the so-called “photosynthesis” begins, the vegetable tower can exhale oxygen and make it suitable to be located nearby residential area or central urban area.

According to the objective of the present invention, each of the vegetable growing bins further comprises at least one first supply tube, at least one second supply tube, and at least one third supply tube; the first supply tube respectively stretches to the cover surface of the vegetable growing bins to form a first supply inlet, the second supply tube stretches to the cover surface of the vegetable growing bins to form a second supply inlet, and the third supply tube stretches to the cover surface of the vegetable growing bins to form a third supply inlet. According these three supply inlets, water, fertilizer, and low-temperature CO₂ can be injected into the vegetable growing bins along the three tubes. The surfaces of the three tubes further contain a plurality of holes. Furthermore, each vegetable growing bin comprises a barcode on its cover surface, which is used for identifying the kinds of the vegetables of the vegetable growing bin.

According to the objective of the present invention, the vegetable tower further contains a main control module which is built inside the main body, and the main control module can automatically ascend and descend inside the main body to perform its identifying, feeding, catching images and monitoring functionalities. In addition, in case of the malfunction of the main control module, the vegetable tower further comprises a spared control module with the same functionalities as the main control module, so that the spared control module can ensure that the growth of the vegetables is under control.

The main control module comprises an identifying system, a feeder, an image capture system, a monitoring system, and a motion system. The identifying system is used for identifying classifications and/or planting details of each of the vegetable growing bins since each vegetable growing bin is equipped with RFID tag, wherein the feeder is used for feeding the vegetable growing bins with various nutrients via the first supply inlet, second supply inlet, and third supply inlet. In the present invention, the feeder comprises water providing sub-system, a fertilizer providing sub-system, and a CO₂ providing sub-system. The purpose of CO₂ providing sub-systems has two folds: 1. It can cool down the soil temperature so that it's very easy to grow those that need low temperature environment. 2. CO₂ is also one of the key elements during vegetable growing process.

The image capture system is used for capturing images of the vegetables of every vegetable growing bin. The monitoring system is used for monitoring a plurality of growth conditions of the vegetable growing bins. The monitoring system comprises a soil moisture/temperature detector, a soil PH detector, a sunshine serving detector, and a CO₂/O₂ concentration detector.

The central management module is electrically connected to the main control module. During the growths of the vegetables, the central management module has a database to compare the images of vegetables captured by the image capture system and the growth conditions of the vegetable growing bins monitored by the monitoring system such that the central management module is able to control the feeder to adjust the feeding volume according to the aforementioned images and growth conditions. The database composes of integrated data of the vegetables, which contains the optimized growth conditions of the corresponding vegetables and images of the vegetables from born to mature. The central management module and the main control module integrate to be an automatic planting-care system to make the growths of the vegetables under well control. The central management module can communicate to the internet to service more consumers. As a result, the consumers can pickup their preferred vegetables and pay the fees via the internet. Furthermore, they can know the current states of the vegetable growing bins in real time, and decide whenever to take the vegetable growing bins home. The consumers can save their time expensed at the traffic jam and reduce the produced carbon volumes. In other words, the present invention combines the issues of carbon-reducing and convenience for obtaining organic foods.

In summary of the descriptions set forth hereinbefore, the vegetable tower according to the present invention allows one or more of the following advantages:
(1) The vegetables of the vegetable tower can absorb CO₂, and therefore the carbon volumes around the atmosphere can be reduced.
(2) The vegetable growing bins of the vegetable tower can slip downstream along the main spiral slide guide, and therefore the driving power can be saved.
(3) The automatic planting-care system of the vegetable tower can save the manpower, and always discover problem/imperfection before it is finally spotted alter it is harvested by human.
(4) The vegetables are cheap organic foods, and the consumers can pickup the vegetables and pay the fees through internet or existing on-line payment system.
(5) The vegetable tower is mainly located in the central urban area. By comparing with the existing “farm-to-dinner table” practice, it can reduce huge CO₂ emission during transportation process of vegetable, and also prevent vegetable from damage during handling and transportation.
(6) The vegetable tower is well protected by strong structure, it is designed to survive under Richter magnitude scale 7 and 65 m/s wind speed. So it can be the best “contingency solution” under extreme environment.
(7) Since the vegetable tower is a near-closed environment, it can be used for high-value traditional Chinese medicine theoretically and make the vegetable tower unlimited commercial benefits.
(8) The vegetable tower comprises a main structure, a plurality of inner structures, and a plurality of assisted devices which keep the vegetable tower operate periodically.
(9) The present invention comprises planting technology, environment-detection technology, monitoring technology, growth-maintenance technology, and quality-inspection technology.
(10) The present invention further involves in skills to qualify the varieties of vegetables and the qualities of soils, nutrients and so on.
(11) The present invention furthermore contains a business model for commercial operation.

### BRIEF DESCRIPTION OF THE DRAWINGS

FIG. 1 is a schematic view showing a structure of a vegetable tower according to the present invention.

FIG. 2 shows a top view and a front view showing a structure of a main body according to the present invention.

FIG. 3a is an enlarged side view of the region A shown in the FIG. 1 and it shows connection relationship between chains and a vegetable growing bin hung on a main spiral slide guide according to the present invention.

FIG. 3b is an enlarged front view of the region A shown in the FIG. 1 and it shows connection relationship between chains and a vegetable growing bin hung on a main spiral slide guide according to the present invention.

FIG. 4 is a perspective view showing a structure of a vegetable growing bin according to the present invention.

FIG. 5 is a perspective view showing a structure of a vegetable tower with a main control module according to the present invention.

FIG. 6 is a block diagram showing functionalities of a main control module according to the present invention.

FIG. 7 is a perspective view showing a main control module and a central management module according to the present invention.

### DETAILED DESCRIPTION OF THE PREFERRED EMBODIMENTS

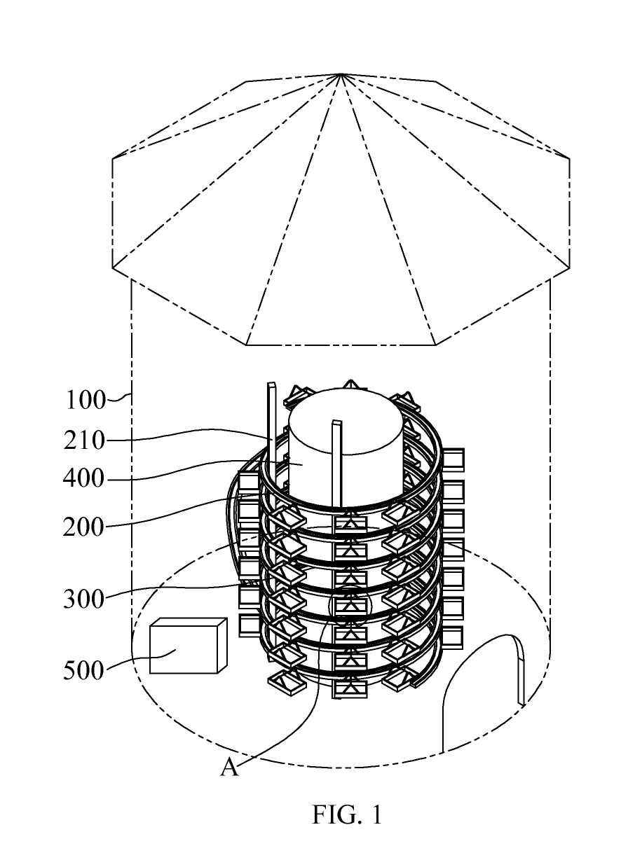

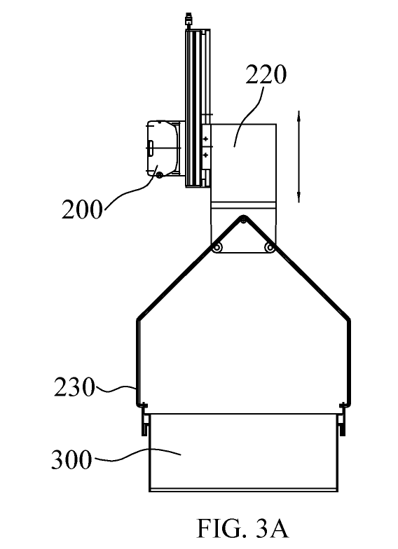

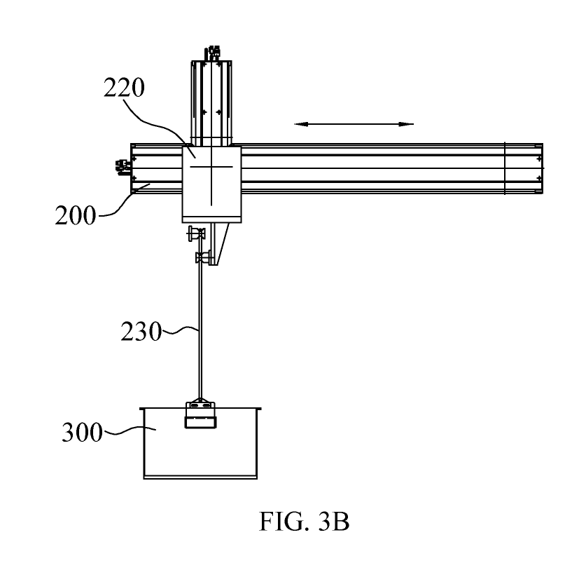

FIG. 1 is a schematic view showing a structure of a vegetable tower according to the present invention. As illustrated in FIG. 1, the main body 100 has a polygonal or cylinder outside shape that enhances the entire structure's strength, wherein the preferred shape is octagon cylinder, so that the main body 100 of the vegetable tower can reduce the resistance from the wind that hits the flat surface of the octagon cylinder. In the present invention, the main body 100 is composed of light-weight components. Therefore, the main body 100 has advantages of high mobility and can be built up easily. As a result, the vegetable tower can be set up at the high population density community or commercial area. A main spiral slide guide 200 is disposed inside the main body 100 and different kinds of vegetable growing bins 300 can be hung on the main spiral slide guide 200 via a plurality of chains. The main spiral slide guide 200 further comprises a side spiral slide guide 210 to install the vegetable growing bins 300. To be emphasized that the structure of connection between the chains and the vegetable growing bins 300 will be clearly illustrated by region A shown in FIG. 3a and FIG. 3b. The vegetable tower further comprises a central elevator 400 located inside the main body 100, and the central elevator 400 enables a maintainer to ascend and descend for trouble shooting or hanging different kinds of vegetable growing bins 300 thereupon. The main body 100 further comprises a temperature control system 500 to keep the inner temperature of the main body 100 stable.

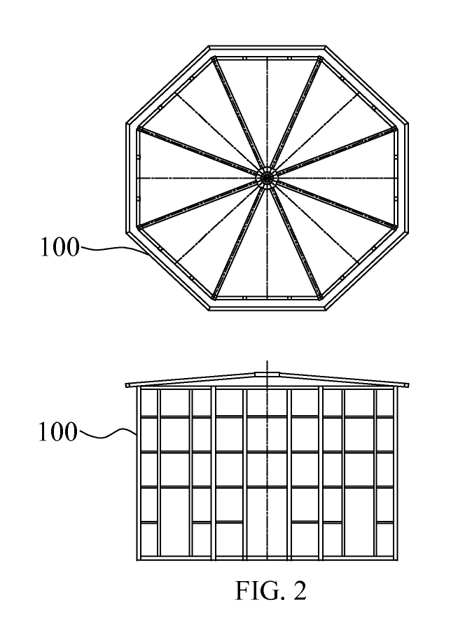

FIG. 2 shows a top view and a front view showing a structure of a main body according to the present invention. As illustrated in FIG. 2, the top view and front view, of the preferred octagon cylinder shape of the main body 100 are shown. The main body 100 is composed of light-weight components, so that the main body 100 has advantages of high mobility and can be built up easily.

FIG. 3a is an enlarged side view of the region A shown in the FIG. 1 and it shows connection relationship between chains and a vegetable growing bin hung on a main spiral slide guide according to the present invention. FIG. 3b is an enlarged front view of the region A shown in the FIG. 1 and it shows connection relationship between chains and a vegetable growing bin hung on a main spiral slide guide according to the present invention. As illustrated in FIG. 3a and FIG. 3b, the vegetable growing bin 300 can be hung on the main spiral slide 200 via the chains 230 and the supporting component 220. In addition, the vegetable growing bins 300 can be installed on the side spiral slide guide, and then consequently ascended to the main spiral slide guide 200 via the momentum of the chains 230 and the side spiral slide guide. Therefore, the vegetable growing bins 300 can slip downstream along the main spiral slide guide 200.

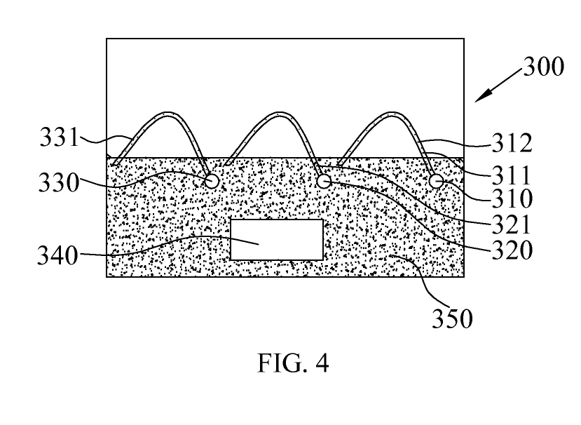

FIG. 4 is a perspective view showing a structure of a vegetable growing bin according to the present invention. As illustrated in FIG. 4, the vegetable growing bin 300 has at least one first supply tube 311, at least one second supply tube 321, and at least one third supply tube 331. The first supply tube 311 respectively stretches to the cover surface of the vegetable growing bin 300 to form a first supply inlet 310, the second supply tube 321 stretches to the cover surface of the vegetable growing bin 300 to form a second supply inlet 320, and the third supply tube 331 stretches to the cover surface of the vegetable growing bin 300 to form a third supply inlet 330. By using these three supply inlets, water, fertilizer, and low-temperature CO₂ can be injected into the vegetable growing bin 300 along the three tubes. The surfaces of the three tubes further contains a plurality of holes 311, and therefore the nutrients, such as water, fertilizer, and low-temperature CO₂ can reach soil 350 of the vegetable growing bins 300 to maintain growth of the vegetables via these holes 311. Furthermore, each vegetable growing bin 300 comprises a barcode 340 on its cover surface, and the barcode 340 is used for identifying the kinds of the vegetables of the vegetable growing bin 300. For example, the vegetables can be organic foods which are selected from a group consisting of cabbage, water celery, spinach, amaranth, and etc. The descriptions of the vegetables are simply exemplary rather than restrictive.

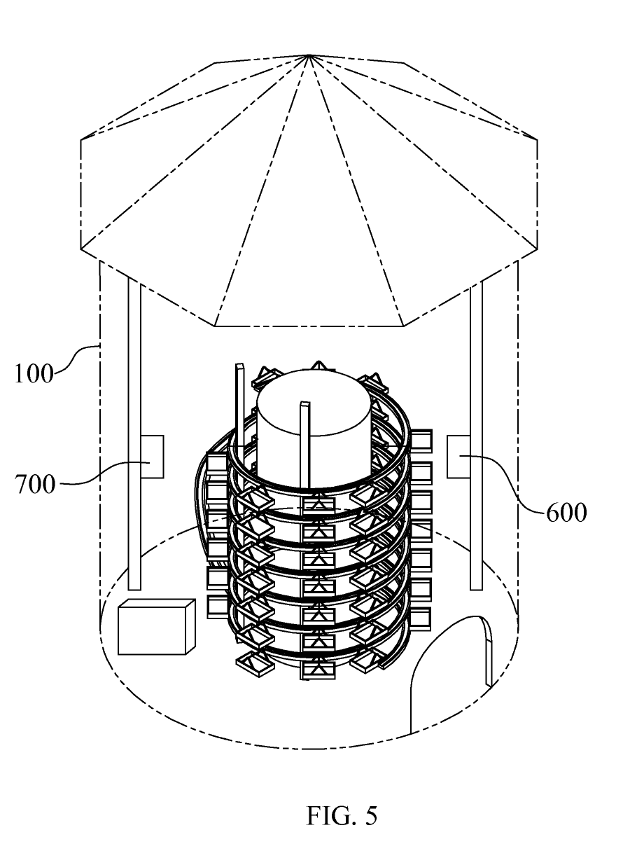

FIG. 5 is a perspective view showing a structure of a vegetable tower with a main control module according to the present invention. As illustrated in FIG. 5, the vegetable tower contains a main control module 600 which is built inside the main body 100, and the main control module 600 can automatically ascend and descend inside the main body 100 to perform identifying, feeding, catching images and monitoring functionalities. In addition, the vegetable tower further comprises a spared control module 700 with the same functionalities as the main control module 600 for preventing the main control module 600 from malfunction, so that the spared control module 700 can ensure growth of the vegetables is under control.

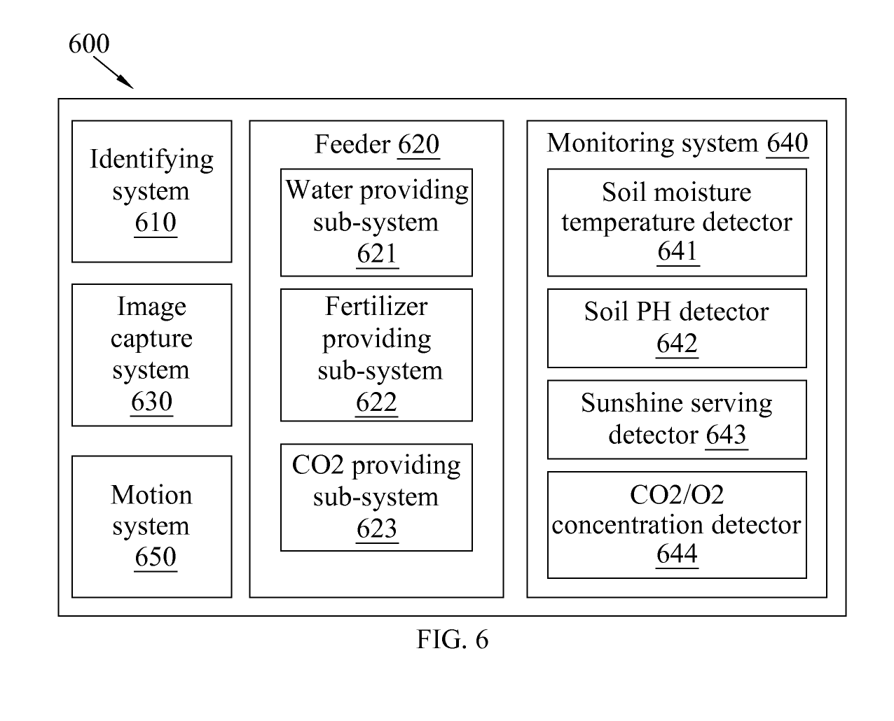

FIG. 6 is a block diagram showing functionalities of a main control module according to the present invention. As illustrated in FIG. 6, the main control module 600 comprises an identifying system 610, a feeder 620, an image capture system 630, a monitoring system 640, and a motion system 650. The functionalities of the main control module 600 are described as following: the identifying system 610 is used for identifying classifications and/or planting details of each vegetable inside the vegetable growing bin through the barcode on the cover surface of the vegetable growing bin. The feeder 620 is used for feeding the vegetable growing bins with various nutrients via the first supply inlet, second supply inlet, and third supply inlet. In the present invention, the feeder 620 comprises a water providing sub-system 621, a fertilizer providing sub-system 622, and a CO₂ providing sub-system 623. Hence, the water providing sub-system 612 feeds the vegetable growing bins water via the first supply inlet 310 (shown in FIG. 4), and water is injected into the soil along the holes of the first supply tube 311 (shown in FIG. 4), wherein the fertilizer providing sub-system 622 feeds the vegetable growing bins fertilizer via the second supply inlet 320 (shown in FIG. 4), the CO₂ providing sub-system 623 feeds the vegetable growing bins low-temperature CO₂ via the third supply inlet 330 (shown in FIG. 4). The image capture system 630 is used for capturing images of the vegetables inside every vegetable growing bin, wherein the images are color, appearance, length of the leaf of the vegetables. Therefore, the maintainer can know the condition of nutrients absorbed by the vegetables, and consequently makes the suitable judgment while trouble shooting, such as adjusting the water providing sub-system 621 to increase/decrease water volume. The monitoring system 640 is used for monitoring several growth conditions of the vegetable growing bins. The monitoring system 640 comprises a soil moisture/temperature detector 641, a soil PH detector 642, a sunshine serving detector 643, and a CO₂/O₂ concentration detector 644. For instance, if the monitor system 640 detects that the soil lacks moisture, the feeder 620 automatically feeds the vegetable growing bin with sufficient water; and if the monitor system 640 detects that the vegetable growing bin has low concentration of CO₂, the feeder 620 automatically feeds the vegetable growing bin with sufficient low-temperature CO₂. Because the growth conditions of the vegetables can not be obtained easily by merely observing the appearances of the vegetables, an auxiliary apparatus for monitoring the physical/chemical parameters of the vegetable growing bins is needed. The motion system 650 is used for rotating the vegetable growing bins to serve sufficient sunshine when the monitor system 640 detects that the vegetables lacks light.

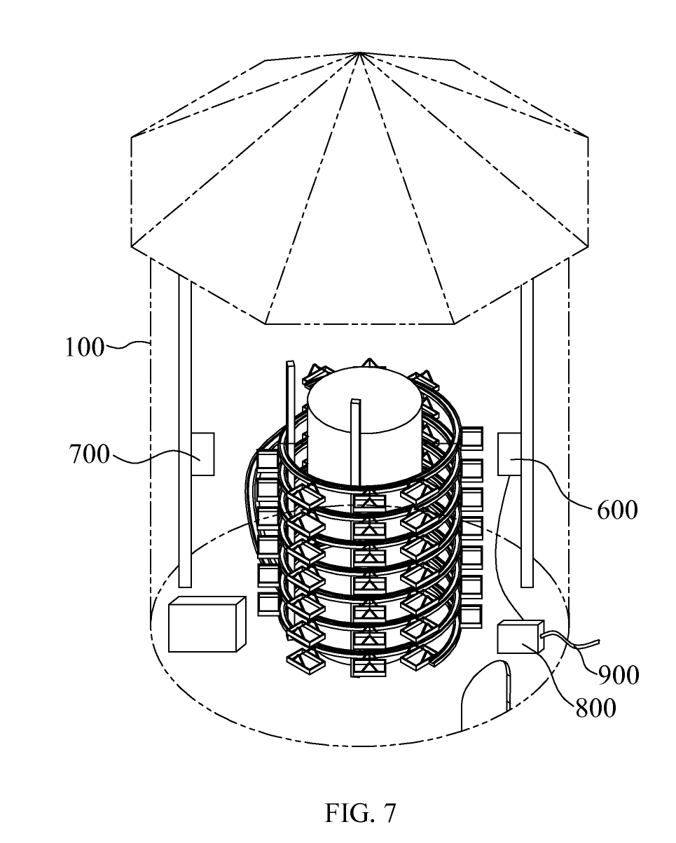

FIG. 7 is a perspective view showing a main control module and a central management module according to the present invention. As illustrated in FIG. 7, the central management module 800 is electrically connected to the main control module 600. While the maintainer hangs the vegetable growing bins upon the main spiral slide guide, the central management module 800 controls the main control module according to the database to feed the vegetable growing bins with a predetermined condition. During the growths of the vegetables, the central management module 800 has the database so as to compare the images of vegetables captured by the image capture system and the growth conditions of the vegetable growing bins monitored by the monitoring system, such that the central management module 800 can control the feeder to adjust the feeding volume according to the aforementioned images and growth conditions. The database composes of integrated data of the vegetables, which contains the optimized growth conditions of the corresponding vegetables and images of the vegetables from born to mature. As a result, the major advantage of the present invention is manpower saving, and the central management module 800 and the main control module 600 are integrated to be an automatic planting-care system to make the growths of the vegetables under well control. In addition, during the growth of the vegetable, the maintainer only needs to conduct the trouble shooting and hang the vegetable growing bins upon the main spiral slide guide. The central management module 800 can service more consumers via internet 900, therefore the present invention takes both power saving effect and users convenience into consideration

As a result, the consumers can pickup their preferred vegetables and pay the fees via the Internet. Furthermore, they can know the current states of the vegetable growing bins on-line, and decide the timing to take the vegetables home. Accordingly, the consumers can save their time expensed at the traffic, and the produced carbon volumes can be reduced. Hence, the present invention combines the advantages of carbon-reducing and convenience for obtaining organic foods.

The descriptions set forth hereinbefore are simply exemplary rather than restrictive. All effectively equivalent modifications, changes or alternations made thereto without departing from the spirit and scope of the present invention are deemed as being encompassed by the field of the present invention defined as the following claims.

What is claimed is:

1. A vegetable tower, comprising:
a main body having a main spiral slide guide; and
a plurality of vegetable growing bins hung on said main spiral slide guide via a plurality of chains, wherein said vegetable growing bins slip downstream along said main spiral slide guide.

2. The vegetable tower of claim 1, wherein each of said vegetable growing bins further comprises at least one first supply tube, at least one second supply tube, and at least one third supply tube, wherein said first supply tube respectively stretches to a cover surface of said vegetable growing bin to form a first supply inlet, said second supply tube respectively stretches to said cover surface of said vegetable growing bin to form a second supply inlet, and said third supply tube respectively stretches to said cover surface of said vegetable growing bin to form a third supply inlet.

3. The vegetable tower of claim 2, wherein said first supply tube, said second supply tube, and said third supply tube contains a plurality of holes on surfaces thereof.

4. The vegetable tower of claim 1, further comprising a main control module built inside said main body to perform identifying, feeding, catching images and monitoring functionalities.

5. The vegetable tower of claim 1, wherein said main body has a polygonal or cylinder shape to reduce wind resistance.

6. The vegetable tower of claim 1, further comprising a central elevator for enabling a maintainer to ascend and descend for hanging said vegetable growing bins upon said main spiral slide guide.

7. The vegetable tower of claim 1, further comprising a temperature control system built inside said main body.

8. A vegetable tower, comprising:
a plurality of vegetable growing bins having at least one first supply tube, at least one second supply tube, and at least one third supply tube, wherein said first supply tube respectively stretches to a cover surface of each of said vegetable growing bins to form a first supply inlet, said second supply tube respectively stretches to said cover surface of said vegetable growing bin to form a second supply inlet, and said third supply tube respectively stretches to said cover surface of said vegetable growing bin to form a third supply inlet; and
a main control module for feeding said vegetable growing bins with a plurality of nutrients via said first supply inlet, said second supply inlet, and said third supply inlet.

9. The vegetable tower of claim 8, wherein said main control module further comprises:
an identifying system for identifying a plurality of classifications and/or planting details of said vegetable growing bins;
a feeder for feeding said vegetable growing bins with a plurality of nutrients via said first supply inlet, said second supply inlet, and said third supply inlet;
an image capture system for capturing a plurality of images of vegetables of said vegetable growing bins; and
a monitoring system for monitoring a plurality of growth conditions of said vegetable growing bins.

10. The vegetable tower of claim 9, wherein said main control module can be ascended and descended to perform identifying, feeding, catching images and monitoring functionalities.

11. The vegetable tower of claim 9, wherein said feeder further comprises a water providing sub-system, a fertilizer providing sub-system, and a CO₂ providing sub-system.

12. The vegetable tower of claim 9, wherein said monitoring system further comprises a soil moisture/temperature detector, a soil PH detector, a sunshine serving detector, and a CO₂/O₂ concentration detector.

13. The vegetable tower of claim 8, further comprising a spared control module for preventing said main control module from malfunction so that said spared control module can ensure that said growth conditions of said vegetable growing bins are under control.

14. The vegetable tower of claim 8, wherein said vegetable growing bins further comprise barcodes.

15. The vegetable tower of claim 8, wherein said main control module further comprises a motion system for rotating said vegetable growing bins to serve sufficient sunshine.

16. A vegetable tower, comprising:
a main body having a plurality of vegetable growing bins;
a main control module built inside said main body, said main control module for feeding, capturing a plurality of images, and monitoring growth conditions of said vegetable growing bins; and
a central management module electrically connected to said main control module, wherein said central management module has a database to compare said images and said growth conditions of said vegetable growing bins such that said central management module controls the operation of said feeder.

17. The vegetable tower of claim 16, wherein said database comprises optimized growth conditions and images of vegetables of said vegetable growing bins.

18. The vegetable tower of claim 16, wherein said main control module further comprises:
an identifying system for identifying a plurality of classifications and/or planting details of said vegetable growing bins;
a feeder for feeding said vegetable growing bins with a plurality of nutrients via said first supply inlet, said second supply inlet, and said third supply inlet;
an image capture system for capturing a plurality of images of vegetables of said vegetable growing bins; and
a monitoring system for measuring a plurality of growth conditions of said vegetable growing bins.

19. The vegetable tower of claim 16, wherein said central management module communicates to internet to service consumers.

20. The vegetable tower of claim 16, wherein said central management module and said main control module are integrated to be an automatic planting-care system.
